(19) United States
(12) Patent Application Publication
(10) Pub. No.: US 2011/0020183 A1
(43) Pub. Date: Jan. 27, 2011

(54) APPARATUS FOR PRODUCING SYNTHETIC FUEL

(76) Inventors: Viliam Storchi, Brescia (IT); Giuseppe Zanoni, Brescia (IT); Franco Dalla Vecchia, Brescia (IT)

Correspondence Address: MCGLEW & TUTTLE, PC, P.O. BOX 9227, SCARBOROUGH STATION, SCARBOROUGH, NY, 10510-9227, US

(21) Appl. No.: 12/446,504

(22) PCT Filed: Feb. 20, 2008
(86) PCT No.: PCT/IB08/50604

§ 371 Date: Apr. 21, 2009

(30) Foreign Application Priority Data
Feb. 21, 2007 (IT) BO2007A000104

(51) Int. Cl. G05D 23/00; B01J 8/00

(52) U.S. Cl. 422/109; 422/187; 422/105

(57) ABSTRACT

The apparatus for producing synthetic fuel comprises a loading unit (2, 3, 4) suitable to receive solid waste to treat, a tank (6) for loading liquid waste and some dosing containers (7, 8, 9) for loading suitable additives. A recycling calibrator unit (10) is suitable to be fed with the waste materials, with the additives and with a diluent oil having the function of diluting the waste materials, forming a fluid mixture. A reaction turbine (11), connected to the sizing unit (10), is suitable to cause the conversion of the kinetic energy into heat energy, in order to allow the development of the process of depolymerization/molecular rearrangement/breakage and reunion of chemical bonds in catalytic way. A duct (28) outlet connected to the reaction turbine (11), injects the fluid mixture in a cyclone separator (13), suitable to allow the separation through gravity of the liquids and solids from the steam. A distillation column (15) receives from the cyclone separator (13) the steams and gases produced during the reaction of depolymerization/molecular rearrangement/breakage and reunion of chemical bonds in catalytic way and produces the separation of the lightest fractions, which are injected in the condenser (17) to obtain the synthetic fuel.

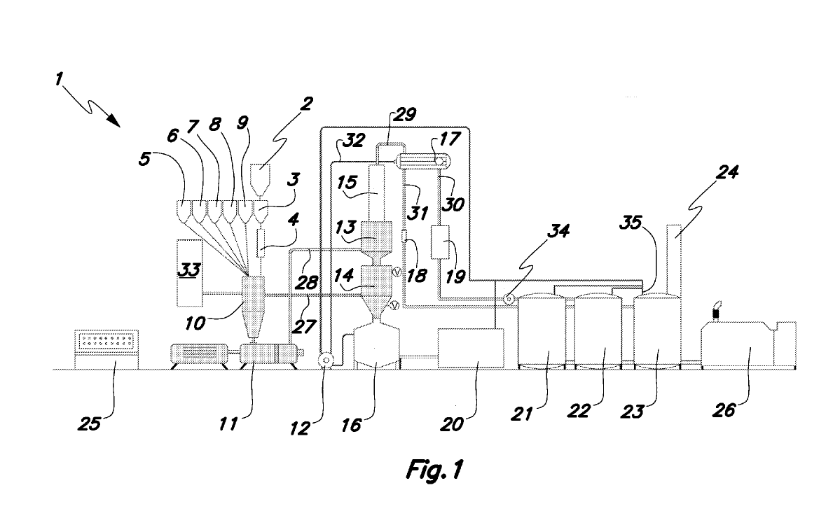

### TECHNICAL FIELD

The present invention relates to a thermo-mechanical apparatus for producing synthetic fuel, obtained through depolymerization/molecular rearrangement/breakage and reunion of chemical bonds in catalytic way of complex organic molecules contained in waste materials of various types, such as urban solid waste, mineral and vegetable exhausted oils, grease, celluloses and polysaccharides, plastic materials and similes, livestock sewage solid waste, oils for transformers containing aromatic polychlorinated, hospital waste sanitary-treated, heavy oils from petroleum reefing, bilge sailing oils, waste from the cleaning of transport and stocking tanks.

### BACKGROUND ART

At present, some processes are known suitable to synthesize combustible products, in particular of the type of diesel oil and gasoline, starting from various waste materials such as solid urban waste, scrap oil and the plastic materials. These processes require, in particular, to feed the waste to a treatment plant in which are adequately treated to obtain the separation of the desired fuel from the residual substances.

U.S. Pat. No. 5,849,964 describes, for instance, a process for the treatment of waste plastic materials, to obtain chemical substances and combustible compounds in the liquid state. In particular, the process provides that the input plastic materials shall undergo an initial treatment of depolymerization/molecular rearrangement/breakage and reunion of chemical bonds in catalytic way in order to obtain a liquid phase and a volatile phase to treat separately. The volatile phase is, then, separated in a liquid phase and a gaseous phase, individually treated to obtain again respective liquid phases that, through hydrogenation, originate the final desired substances.

The European Patent EP 1.538.191 describes a process to obtain combustible oil, which provides for mixing waste material containing hydrocarbons to an additive oil, for placing this mixture in a processing circuit and for the same mixture being separated through distillation, a treatment from which is obtained the desired fuel and the scrap residuals are separated. More precisely, the process provides for the molecular bonds of the entering hydrocarbons to be broken by thermal-catalytic cracking reaction, giving rise to a mixture of lighter substances that can be separated through distillation, and for the heat gain required by the cracking reactions, to be derived mainly from the transformation of the kinetic energy. The thermal energy required is, in fact, given to the stream of mixture of additive oil and waste through suitable agitators acting countercurrent with respect to the pumping means of the stream itself. This allows a greater thermal-kinetic efficiency, and therefore a greater economic convenience, compared to the traditional methods of conduction heating through the walls of the container.

The known processes previously described, and in particular the method described in the European Patent EP 1.538.191, allow to usefully exploit various kinds of waste, among which also the heterogeneous mixtures such as municipal solid waste, but they do not guarantee obtaining a standardized final product pure and of high quality.

In particular, it has been observed that the described processes of known type imply the development, during the reaction phase, of undesired substances. These substances, in particular those belonging to the group of the olefins, such as the propylene or higher homologues, are typical by-products of the reactions of catalytic cracking of the hydrocarbons and they reduce the quality level of the final product. In fact, the mentioned substances, if present in a diesel fuel, can cause damages to the fuel feed system of the diesel engines, in particular the blockage of the injectors. Furthermore, these substances are characterized by a non negligible odorigenous impact.

Furthermore, it has been observed that the mentioned known processes lead to the formation of conspicuous amounts of debris, characterized by the presence of substances of the type of the asphaltenes, which have to be discharged in specialized plants further to their separation from the final product.

### DISCLOSURE OF INVENTION

### Disclosure

The aim of the present invention is to overcome the cited drawbacks by devising an apparatus which enables to obtain a synthetic fuel conforming to the required specifications, in particular a fuel characterized by a low concentration of various undesired substances commonly present in the synthetic fuels, such as olefins and debris containing high quantities of asphaltenes.

Within this scope it is a further aim of the claimed invention to devise an apparatus which enables to operate with more productive efficiency and to effectively reduce the environmental impact of the process of depolymerization/molecular rearrangement/breakage and reunion of chemical bonds in catalytic way of the hydrocarbons, in particular reducing the produced waste materials, the harmful substances and the bad smells emitted during the production phase and in the finished product.

A further aim of the present invention is to provide an apparatus which allows improving the quality of the product and the efficiency of the production process compared with the known techniques, through the systematic monitoring of the parameters of the reaction.

Another aim of the present invention is to provide an apparatus of simple constructive and functional conception, equipped with a certainly reliable functioning, versatile in use, and also relatively economical, and which is manageable from a remote position.

The cited aims are reached, according to the claimed invention, by the apparatus for producing synthetic fuel, through depolymerization/molecular rearrangement/breakage and reunion of chemical bonds in catalytic way of complex organic molecules contained in waste materials, which is characterized in that it comprises a loading system suitable to receive the solid waste materials to be treated; a tank for loading liquid waste; dosing containers for loading adequate catalyzing, neutralizing and reacting additives; a recycling sizing unit, suitable to be fed with the said waste materials, with the said additives and with a diluent oil having the function to dilute and to fluidize the said input waste materials, forming a fluid mixture, to facilitate its circulation and to allow the reactions of depolymerization/molecular rearrangement/breakage and reunion of chemical bonds in catalytic way; a reaction turbine connected to the said sizing unit, suited to cause the conversion of the kinetic energy into thermal energy, with corresponding temperature increase of the said fluid mixture, to allow the development of the process of depolymerization/molecular rearrangement/breakage and reunion of chemical bonds in catalytic way; a duct outlet connected to said reaction turbine and kept in depression by a vacuum pump, to inject the said fluid mixture into a cyclone separator, suitable to allow the gravity separation of the liquids and the solids from the steams; a distillation column suitable to receive from said cyclone separator the steams and gases produced during the said reaction of depolymerization/molecular rearrangement/breakage and reunion of chemical bonds in catalytic way and to produce the separation of the lighter fractions that are fed in a condenser to obtain the synthetic fuel in liquid phase.

### DESCRIPTION OF DRAWINGS

Description details of the invention will be further evident in the illustrations of preferred embodiments of the apparatus for producing synthetic fuel according to the invention, illustrated in the guideline drawings attached, wherein:

The only FIGURE illustrates a schematic overall representation of the claimed apparatus for producing synthetic fuel.

### BEST MODE

With reference to such FIGURE, 1 refers to the apparatus for producing synthetic fuel through depolymerization/molecular rearrangement/breakage and reunion of chemical bonds in catalytic way of carbonaceous molecules contained in waste materials.

The apparatus 1 provides for a fixed structure, not illustrated, preferably extended on different levels, equipped, in its upper part, with a container 2 of the type commonly known as ‘big bag’, suitable to receive the solid waste material to be treated. The container 2 is arranged linked to an underlying loading hopper 3 suitable to allow the continuous feeding of an underlying loading device 4 in absence of air. Next to the loading device 4, the apparatus 1 provides for a first tank 5 for loading an input oil, a second tank 6 for loading liquid waste, and also further tanks or dosing containers 7, 8, 9 for loading adequate catalyzing, neutralizing and reacting substances. The loading device 4 and the tanks 5, 6, 7, 8, 9 feed through respective output ducts an underlying recycle sizing device 10. The recycle sizing device 10 is suitable to prepare a mixture dispersed in diluent oil, calibrated to be fed in a mechanothermal device 11 basically consisting of a reaction turbine.

The feeding oil serves the purpose of diluting and fluidizing the flow of incoming material, thus facilitating the circulation in the following circuits and allowing the reactions of depolymerization/molecular rearrangement/breakage and reunion of chemical bonds in catalytic way.

The reaction turbine 11 is of the type comprising a mechanical stirrer, activated rotatably by a suitable drive, which generates a countercurrent stream with respect to the movement of the incoming fluid. This causes the conversion of the kinetic energy in heat energy and a corresponding increase of the temperature of the fluid, which allows the development of the process of depolymerization/molecular rearrangement/breakage and reunion of chemical bonds in catalytic way.

This result is obtained, in particular, in a known way, through an asynchronous drive connected to the turbine and controlled by an electronic converter that, through a complex vectorial algorithm, allows accelerations from 0 to the maximum speed in less than 100 ms and decelerations in less than 80 ms.

The reaction turbine 11 is equipped with an outlet duct 28, arranged in the upper part, in which the mixture is injected into a circuit maintained in depression by a vacuum pump 12. The mixture is thus tangentially injected into a cyclone separator 13, suitable to allow the gravity separation of the liquids and solids from the steams.

The cyclone separator 13 is arranged linked to a separating chamber 14 below, where the residual solid and liquid materials fall, and to a superjacent distillation column 15, where the steams and gases are entrained, produced during the reactions of depolymerization/molecular rearrangement/breakage and reunion of chemical bonds in catalytic way. In the separating chamber 14 are placed adequate control viscometers V. The residual solid materials are collected at the bottom of a waste tank 16; the liquids are extracted and sent back to the sizing device 10 through a recycle duct 27.

In the distillation column 15 the separation of the heaviest fractions of the present steams takes place; the lighter fractions are discharged from the upper part of the column 15 and are injected through a duct 29 into a condenser 17, where the passage into liquid state takes place. The incondensable gases that gather in the condenser 17 are suctioned, through a duct 32, from the vacuum pump 12, which maintains the whole circuit in depression, and subsequently injected in a suitable collection tank 23. The product in the liquid phase is collected at the bottom of the condenser 17 and sent, through a conveying duct 30, to a suitable storage tank 21. The conveying duct 30 is equipped with a valve, which allows the recovery of the raw product for the in-process-quality inspections in a suitable control tank 19. For the process controls the condenser 17 is preset to send, through the Florence system for the hydrocarbons/water separation, the aqueous phase to a device 18 for measuring the pH, through a duct 31. The storage tank 21 is placed linked to a further conservator tank 22.

A head pump 34 allows overcoming the depression of the plant in order to guarantee the recovery of the finished product.

The tank 23 for collecting the process incondensable gases is equipped with a duct 35, arranged on its upper part, which is placed linked to the tanks 21, 22, thus allowing the collection of the steams emitted by the stored products. The said tank 23 is linked to the device 24 for the abatement of the steams of various types, for instance of the active carbons filtration type, which allows the purification before the discharge into the atmosphere.

The plant also comprises a generator 26 for producing electricity through the fuel produced by the apparatus, and a control console 25, which, through suitable processing means, allows to computer-manage all the functioning parameters of the apparatus.

The functioning of the apparatus for producing synthetic fuel is easily understandable from the description above.

The waste to be treated are manually inserted by an operator or by using loading devices in the container 2, after having undergone a preliminary process of selection and preparation, aiming to remove the materials that cannot be treated, such as metals, rubble, glass and to an adequate granulometric reduction and of humidity.

The waste contained in the container 2 are automatically transferred in the hopper 3 and from here into the sizing unit 10, through the suitable loading device 4 in absence of air, with a flow rate proportioned to the required production rate. The flow rate of the waste input into the sizing unit 10 determines, automatically or through a manual intervention, also the flow rate of the input oil injected into the tank 5, in order to guarantee the correct composition of the mixture. Likewise the total flow rate into the sizing unit 10 determines, automatically or through a manual intervention, the flow rate of the additives coming from the dozing containers 7, 8, 9.

The flow rate of the above-mentioned additives can also be further adjusted automatically, through electronically controlled actuators activated from the control console 25, according to the information coming from the detection and control system arranged downstream of the plant, such as for instance a device 18 for measuring the pH and/or online viscometer V. This allows modifying in real time the control parameters of the process according to the features of the obtained product.

The dosing containers 7, 8, 9 can contain a catalyst and one or more neutralizers, such as oxides, carbonates or hydrogen-carbonates of alkaline or alkaline-earth metals, such as for instance slaked lime or Solvay soda, according to the type of waste material introduced as input, reaction additives for controlling the olefins and the asphaltenes. Outer measures to detect the bromine number in the product allow, through the console, to gauge the amount of additives.

The reaction turbine 11 is suitable to give energy to the fluid as described above, increasing its temperature up to nearly 350° C. The temperature regulation takes place automatically, varying the rotation speed of the stirrer. The temperature rise of the fluid, in presence of the catalysts, causes the activation of the reactions of depolymerization/molecular rearrangement/breakage and reunion of chemical bonds in catalytic way of the carbonaceous molecules in the fluid. The reacting mixture is pushed, by the turbine, in the following duct 28 of the circuit, and it enters tangentially into the cyclone separator 13. The products of the reaction comprise a mixture of gases and steams and an ensemble of residual substances in solid and liquid state. The said solid and liquid residual substances fall for gravity from the cyclone separator 13 into the separating chamber 14 below, where the liquid component is collected and recycled in the sizing unit 10. Furthermore, in the cyclone separator 13 the increase of surface of the fluid facilitates its evaporation, increasing the efficiency of the process. The residual solid component is gathered and destined to the drying and to the use destination on the grounds of chemical and physico-chemical analysis.

The gaseous component of the product of the reactions of depolymerization/molecular rearrangement/breakage and reunion of chemical bonds in catalytic way is suctioned in the distillation column, where the condensation and the separation of the heaviest fractions of the constituents of the mixture take place, as previously described. The extension of the distillation column 15 and the realization of a high number of plates, to which correspond points of draining of the condensed fractions, allow obtaining as final product a synthetic mixture of hydrocarbons with predetermined fractions.

The lighter part of the steams condenses in the condenser 17. The extraction of incondensable gases from the condenser 17 and the correct functioning of the branch in depression are assured by the vacuum pump 12, which maintains a constant pressure of 0.3-0.5 bar.

The product, extracted from the condenser in the liquid phase, is conveyed through the duct 30 to the tank 21, where it is stored. A further level-control tank 33 and the further measurement instruments allow the continuous control and the automatic adjustment of the process parameters. If necessary, a further tank 22 is available, which can be used for storing the finished product.

The waste incondensable gases produced during the reactions of depolymerization/molecular rearrangement/breakage and reunion of chemical bonds in catalytic way and the steams present in the storage containers of the finished product are collected at the top of the tanks in the duct and piped to a unit for treating the gases, for instance of the type of active-carbon filtration.

As known, in a chemical system having constant volume and pressure the asymptotic reaching to the line describing the yield to the thermodynamic equilibrium takes place following specific reaction isotherms. In the claimed process the reaction of depolymerization/molecular rearrangement/breakage and reunion of chemical bonds in catalytic way is carried out at the temperature of 350° C., reached by the mass consisting of the matrix in treating, the homogenization aid, catalyst finely subdivided and in intimate contact, through the transferring of kinetic energy from the turbine into heat energy in system with low heat exchange with the outside (adiabatic conditions). The residence time of the reagents in the reactor would have to be enough for the desired chemical reactions to be carried out with the maximum efficiency, thwarting undesired side and/or competitive reactions. Therefore the parameters ‘time factor’ and ‘space velocity’ become strategic, together with the invariance of the operating temperature. The temperature reached through the variation of the number of revolutions of the turbine and the recycle of the reagents that did not intervene in the reaction, are effective only if the reaction isotherm remains univocal and thanks to the temperature oscillations contained within the interval of 0.5-2%, thus allow to keep the space velocity within tolerable oscillations.

Therefore, the proposed system faces and solves the problems highlighted above, since, on the one hand it provides a calibrated reactive complex, and on the other it has effective control and intervention automations, capable of maintaining the reaction temperature constant with deviations within 0.3%, from which derives the invariance of the space velocity and of the set reaction time.

The reaction parameters are completely controlled through electronic sensors for the various physical quantities. An electronic control consisting of conversion elements of analog/digital signals creates comparisons and process operations. The aim of the electronic control of the process is to optimize the chemical properties of the product through the adjustment of the parameters of the process, which the researches have demonstrated being more sensitive. This is essentially realized with the introduction of three adjustments for controlling the opening of the electronically controlled delivery valve to the reactor, the speed control of the turbine and the speed control of the suction pump.

The control strategy of the electronically controlled delivery valve to the reactor of the mixture aims to maintain the inlet velocity of the reagents as steady as possible. This condition proved to be useful to reduce the intervention of side reactions and therefore to the production of undesired substances (olefins, asphaltenes). The control of the opening of the proportional electronically controlled valve is obtained feedbacking the pressure measured at the delivery of the turbine on a setpoint that can be set by the user.

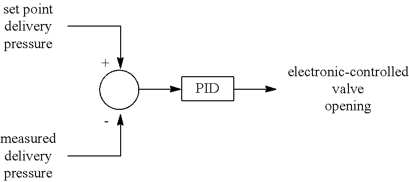

The turbine speed is adjusted in order to keep constant the temperature of the mixture which is delivered to the reactor. The measures chosen to adjust the speed are the temperature detected through thermocouple and the current absorbed by the turbine. Therefore, the control is of the multi-loop type. The first loop of the controller closes on the measured temperature; it has slow dynamics and it allows the control to adapt to the evolution on long time of the system (ambient temperature, insulation conditions, process starting, etc. . . . ).

The second loop, closed on the current value measured by the inverter and therefore on the instantaneous value of power absorbed by the plant, has fast dynamics and it allows to react to the variations on short times of the system (variation of the mixture composition) reducing the typical oscillations in steady-state conditions, fast and not wide, of the temperature.

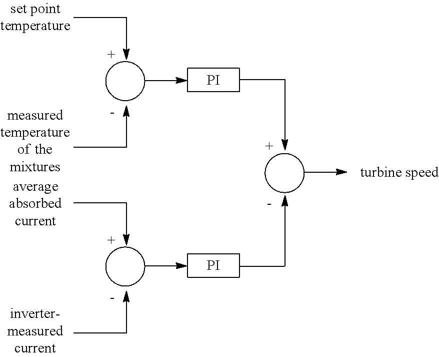

To adjust the velocity of the suction pumps, the depression of the suction duct collects the steams from the reactor for their subsequent condensation. In order to keep homogeneous the physical conditions at which the reaction develops, it is necessary that the value of this depression is kept constant. The rotation speed of the suction pump is adjusted feedbacking the depression measured at the suction duct on a set point that can be set by the user.

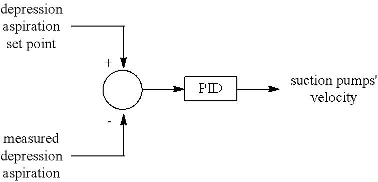

The control makes use of different PID in numerical form, described by the equation:

$$u [ k ] = {K}_{P} ɛ [ k ] + {K}_{I} {\sum }_{n = 0}^{k} ɛ [ n ] + {K}_{D} ( ɛ [ k ] - ɛ [ k - 1 ] )$$

In which

ε[k]

is the error signal,

u[k]

is the controlled variable,

### K_{P}, K_{I}, K_{D}

respectively the proportional, integral and derived gains.

The solution proposed provides also, in case for incidental reasons the reaction proceeds by forming undesired products, for the possibility to remedy the cited problems and to guarantee an effective abatement of the undesired materials such as the olefins and the degradation of the asphaltenes. With this aim, it is provided the discharge of adequate additives, contained in the dozing containers 7, 8, 9. These additives comprise substances supplying hydrogen, such as dihydrophenanthrene, cyclohexene, tetraline, benzyl alcohol, tetrahydrochinoline, decalin, diphenyl methane for the abatement of the olefins, and substances capable of thermally producing radical species, such as octyl nitrate, the methyl-ter pentyl ether or the MTBE.

The apparatus described reaches the aim of producing synthetic fuel of high quality, corresponding to the specifications required in particular for the low concentration of undesired substances, such as the olefins and the asphaltenes.

A prerogative of the claimed apparatus consists of allowing to operate with more productive efficiency and to effectively reduce the environmental impact of the process of depolymerization/molecular rearrangement/breakage and reunion of chemical bonds of the hydrocarbons in catalytic way, in particular reducing the waste materials produced, the harmful substances and the bad smells emitted during the production.

The invention aims also at being an efficient and strategic alternative to the system for treating waste through incineration, allowing the recovery of combustible feedstock with diversified and movable utilization (electricity and auto-traction), likewise contributing to reduce the atmospheric pollution both during the process, and through the production of low-emission-particle fuel, and to supplying energy from fossil fuel by resorting renewable sources of energy.

Materials adopted for the actual realization of the invention, as well as their shapes and sizes, can be various, depending on the requirements.

Where technical features mentioned in any claim are followed by reference signs, those reference signs have been included for the sole purpose of increasing the intelligibility of the claims and accordingly such reference signs do not have any limiting effect on the scope of each element identified by way of example by such reference signs.

1. An apparatus for producing synthetic fuel, through transformation of complex organic molecules contained in waste materials, the apparatus comprising:
a loading unit for receiving the solid waste materials to be treated;
a loading device in absence of air receiving said solid waste materials via said loading unit;
a tank for loading liquid waste;
a tank for loading a diluent oil;
dosing containers, for loading adequate catalyzing, neutralizing and reacting additives;
a recycling sizing unit, suitable to be fed with said waste materials, with said catalyzing, neutralizing and reacting additives and with said diluent oil having the function of diluting and fluidizing said input waste materials, forming a fluid mixture, in order to facilitate its circulation and to allow the reactions of transformation of complex organic molecules contained in said waste materials;
a reaction turbine connected in output to said sizing unit, suited to cause the conversion of the kinetic energy into thermal energy, with corresponding temperature increase of said fluid mixture, in order to allow the development of the process of transformation of complex organic molecules contained in said waste materials;
a cyclone separator connected in output to said reaction turbine, through a duct kept in depression by a vacuum pump, and suitable to receive said fluid mixture in order to allow the gravity separation of the liquids and the solids from the steams;
a distillation column receiving from said cyclone separator the steams and gases produced during said reaction of transformation of complex organic molecules contained in said waste materials and to produce the separation of the lighter fractions that are injected into a condenser to obtain the synthetic fuel in liquid phase;
an underlying separating chamber, suitable to receive from said cyclone separator, through fall, residual solid and liquid materials, said residual solid materials being collected at the bottom of a discharging tank and said residual liquid materials being extracted and sent back to said sizing device through a suitable recycle duct.

2. An apparatus according to claim 1, wherein said loading unit comprises a container for receiving said solid waste materials to be treated, a loading hopper arranged connected to said container and suitable to allow the continuous feeding of said loading device in absence of air, destined to feed said recycle sizing unit.

3. An apparatus according to claim 1, wherein said reaction turbine comprises a mechanical stirrer, activated in rotational way by a suitable drive, suitable to generate a countercurrent stream with respect to the movement of said incoming fluid mixture, in order to cause the conversion of the kinetic energy into heat energy and a corresponding increase of the temperature of the fluid mixture, in order to allow the development of said process of transformation of complex organic molecules contained in said waste materials.

4. An apparatus according to claim 1, wherein said synthetic fuel in liquid phase, collected at bottom of the condenser, is sent, through a transport duct, to suitable storage tanks.

5. An apparatus according to claim 4, wherein said transport duct is equipped with a valve, which allows the recovery of the raw product for the in-process-quality inspections in a suitable control tank.

6. An apparatus according to claim 1, wherein the incondensable gases that gather in said condenser are suctioned, through a duct, by said vacuum pump and subsequently injected into a suitable collection tank, linked to a steams-abatement device, which allows its purification before the discharge into the atmosphere.

7. An apparatus according to claim 4, wherein said collection tank is equipped with a duct, which is arranged linked to said storage tanks for collecting the steams emitted by said synthetic fuel in the liquid phase.

8. An apparatus according to claim 1, further comprising a generator for producing electricity fed through said synthetic fuel produced by the apparatus.

9. An apparatus according to claim 1, wherein the feeding flow of the additives can be adjusted automatically, through suitable electronic-controlled actuators, according to the information coming from the detection and control systems comprising a device for measuring the pH.

10. An apparatus according to claim 1, wherein said distillation column is extended in order to realize a plurality of points of draining of the condensed fractions, in order to obtain, as final product, a synthetic mixture of hydrocarbons with predetermined fractions.

11. An apparatus according to claim 1, further comprising electronic control means of the parameters of said process of transformation of complex organic molecules contained in said waste materials, comprising adjustment means for controlling the opening of an electronically controlled delivery valve to the reaction turbine, the speed control of the reaction turbine and the speed control of the suction pump.

12. An apparatus according to claim 11, wherein said speed of the reaction turbine is adjusted in order to keep constant the temperature of the mixture being delivered to said reaction turbine, measuring the temperature through thermocouple and the current absorbed by said reaction turbine.

13. An apparatus according to claim 11, wherein said control of the opening of the electronically controlled delivery valve to said reaction turbine is obtained feedbacking the pressure measured at the delivery of the turbine on a setpoint, which can be set by the user.

14. An apparatus according to claim 11, wherein said speed control of said vacuum pump is obtained feedbacking the depression measured at the suction duct on a setpoint, which can be set by the user.

15. An apparatus according to claim 1, wherein said additives comprise some substances supplying hydrogen, such as dihydrophenanthrene, cyclohexene, tetraline, benzyl alcohol, tetrahydrochinoline, decalin, diphenyl methane for the abatement of the olefins, and some substances capable of thermally producing radical species, such as octyl nitrate, the methyl-ter pentyl ether or the MTBE.

16. An apparatus according to claim 6, wherein said collection tank is equipped with a duct, which is arranged linked to said storage tanks for collecting the steams emitted by said synthetic fuel in the liquid phase.
